(19) United States
(12) Patent Application Publication
(10) Pub. No.: US 2005/0230544 A1
(43) Pub. Date: Oct. 20, 2005

(54) Arrangement for coating interior trim components in passenger aircraft while complying with relevant fire protection standards and at the same time improving thermal comfort

(76) Inventors: Heinz-Peter Busch, Weyhe (DE); Georg Niedzwiedzki, Bremen (DE)

Correspondence Address: OSTROLENK FABER GERB & SOFFEN, 1180 AVENUE OF THE AMERICAS, NEW YORK, NY, 100368403, US

(21) Appl. No.: 11/106,784

(22) Filed: Apr. 15, 2005

Related U.S. Application Data
(60) Provisional application No. 60/606,645, filed on Sep. 2, 2004.

(30) Foreign Application Priority Data
Apr. 17, 2004 (DE) DE 102004018737.1

(51) Int. Cl. B62D 25/14

(52) U.S. Cl. 244/118.5

(57) ABSTRACT

The application describes an arrangement for coating interior trim components in passenger aircraft while complying with relevant fire protection standards and at the same time improving thermal comfort, with a layer arrangement which comprises a transparent layer and further functional layers, wherein the layer arrangement can be applied to the interior trim components, in particular to the side of the cabin wall which faces the passenger. At least in some regions, a rear coating that faces away from the interior of the cabin of the passenger aircraft has been applied to the transparent layer. Due to the rear coating of the transparent layer, the thermal comfort of passengers which are seated in the window regions of the cabin is believed to be enhanced. Furthermore, the rear coating may make it possible to comply with the relevant fire protection standards even with the use of foils made of polyolephines, for example polyethylene foils or polypropylene foils, which are more economical when compared to PVF (polyvinyl fluoride) foils and/or PVDF (polyvinylidene fluoride) foils, to form the transparent layer with the rear coating. Furthermore, the application of the layer structure to the interior trim components including the transparent layer may also serve decorative design purposes.

### FIELD OF THE INVENTION

The present invention relates to an arrangement for coating interior trim components in passenger aircraft to an interior trim component and to a method of manufacturing an interior trim component.

### BACKGROUND OF THE INVENTION

Coatings on interior trim components of passenger aircraft, used for the purpose of improving thermal comfort, are known from the state of the art. These are thin coatings applied to interior trim components of the passenger cabin. To this effect, the coating is applied, in particular by evaporation coating, to the surface of the interior trim components, which components face towards the inside of the passenger cabin.

Due to the thinness of the coatings used to improve thermal comfort, their chemical composition and the fact that these coatings are applied to the outer surfaces of the interior trim components, the durability of known coatings or layer arrangements is poor. In particular, the known coatings applied to the outer surface of interior trim components are not resistant to perspiration from sweaty hands and/or to additional mechanical effects as they are encountered for example from the use of cleaning appliances on the surfaces of the interior trim components.

Known coatings are less than 1 μm in thickness. As a result of this, known coatings applied to the outer surfaces of interior trim components in passenger aircraft cabins, which coatings are applied to increase the thermal comfort in passenger aircraft cabins, are only suitable to a limited extent for practical long-term use.

### SUMMARY OF THE INVENTION

An exemplary embodiment of the present invention relates to an arrangement for coating interior trim components of a cabin in a passenger aircraft while complying with relevant fire protection standards, the arrangement comprising:
a layer arrangement with a first transparent layer and a plurality of second functional layers,
wherein the layer arrangement is appliable to the interior trim components;
a rear coating,
wherein the rear coating is applied to the first transparent layer in at least one region thereof at a side of the first transparent layer that faces away from an interior of the cabin of the passenger aircraft.

In an exemplary embodiment, the coating that has been applied to the interior trim components has a low thermal emission coefficient F, so that the coating reflects as high a percentage as possible of the radiation emanating from a passenger, especially of the impinging infrared radiation, back to the cabin of the passenger aircraft. Preferably, the emission coefficient of the coating is less than 0.5 so that more than 50% of the impinging infrared radiation is reflected back into the interior of the cabin of the passenger aircraft.

The coating thus reflects the heat radiation conveyed by those passengers seated near the interior trim components back into the interior of the passenger aircraft. Due to the reflected infrared radiation, the body heat emission of passengers seated near the interior trim components, in particular seated near windows of the passenger cabin, is reduced, thus largely preventing a sense of feeling cold so that the thermal comfort of these passengers is improved. The sensation of feeling cold, which is in particular experienced on long-haul flights by passengers seated near the interior trim components in the region of the windows, is reduced by the reflective coating, without this resulting in a significant change in the surface temperature of the interior trim components themselves.

The coating can for example comprise metal oxides, in particular indium-tin oxide. Silver compounds and the like may also be used, and purely metallic coatings, for example gold or silver are also imaginable.

The coating may be applied either directly to the interior trim components and/or to the window surfaces or to a carrier foil. Furthermore, additional plastic foils, for example for decorative purposes, protective purposes or the like, can be applied to the interior trim components and/or the window surfaces. Due to the thinness of the coating being below 1 μm, any plastic foils that may be arranged behind the coated carrier foils, such as for example colouration foils or directly-coloured interior trim components, continue to be easily visible.

Furthermore the relevant fire protection standards applying in the field of passenger-related civil aviation need to be complied with. This means that, in the case of a fire, the interior trim components and any plastic foils applied must only emit a defined and limited amount of thermal energy (so-called maximum heat-release value).

It may be possible to provide an arrangement for decorating interior trim components in passenger aircraft while complying with the relevant fire protection standards and maintaining in-service usability, while at the same time improving the thermal comfort and keeping production costs low.

Because, according to an embodiment, at least in some regions a rear coating has been applied that faces away from the interior of the cabin of a passenger aircraft, good abrasion resistance and thus durability of the coating is ensured, while at the same time the thermal comfort is improved, the relevant fire protection standards are complied with, and production costs are kept low.

Because the transparent layer may be permeable at least to infrared radiation, application of the heat-reflective coating on the rear of the transparent layer may become possible. This is believed to result in special durability and resistance of the coating to external environmental influences because said coating can for example no longer be damaged as a result of perspiration from sweaty hands and/or as a result of cleaning processes.

Because the rear coating of the transparent layer may be formed by a metal coating, for example a conductive metal oxide coating and/or a metal coating of a thickness below 2 μm, adequate reflection, into the interior of the passenger aircraft, of the heat radiation emitted by persons seated in the window region is ensured. At the same time, due to its thinness, the metal coating and/or metal oxide coating is not perceptible to the naked eye. Further functional layers, which are arranged behind the transparent layer comprising the rear coating, for example a colouration layer in the form of a dyed-through plastic foil or the like, remain visible through the coating from the outside so that the aesthetic overall appearance of the decoration of the interior trim component may not be affected.

According to a further embodiment of the arrangement, the transparent coating is formed by a plastic foil, preferably a polyolephine plastic foil, in particular by a polypropylene or a polyethylene foil. This results in what is believed to be an advantage of an embodiment according to the invention, in that the transparent layer is permeable to impinging infrared radiation so that a particularly durable arrangement of the heat-reflective coating on the rear of the transparent layer—i.e. on the side facing away from the interior of the passenger aircraft—becomes possible. Furthermore, due to the rear coating, the use of polypropylene foils or polyethylene foils, which are more economical when compared to PVF (polyvinyl fluoride) foils and/or PVDF (polyvinylidene fluoride) foils, becomes possible, although, up to now, with the use of said more economical foils it has not been possible to comply with the relevant fire protection standards applying to passenger aircraft construction. However, as has surprisingly been found in extensive test series in a measuring cabin simulating the interior of a passenger aircraft cabin, due to the rear metal coating and/or metal oxide coating of the polypropylene foil or polyethylene foil, in the case of a fire the heat input into the foil may be reduced to such an extent as a result of reflection of infrared radiation that even with the use of polyethylene foils and/or polypropylene foils in the formation of the transparent layer, the heat-release values of 65 kW min/m², which are the maximum permissible values for compliance with the fire protection standards, can be achieved. This has been tested in conjunction with a structure that is representative of the design of the component.

Thus the arrangement according to the invention may make it possible to increase the thermal comfort in window regions and/or marginal regions of passenger aircraft cabins while at the same time complying with the relevant fire protection standards, all with the use of the more economical polypropylene foils or polyethylene foils. Furthermore, due to its application on the rear of the transparent coating, the coating to increase the thermal comfort has an extremely long service life and is extremely durable so that the arrangement according to the invention is usable and ready for series production. As a side effect, the arrangement according to the invention also makes it possible to decorate interior trim components of passenger aircraft, for example by using additional functional layers, e.g. colouration layers, structural coatings and carrier layers etc. However, the transparent layer in itself may enhance the aesthetic effect of the respective interior trim component by providing the latter with a glossy appearance.

### BRIEF DESCRIPTION OF THE DRAWINGS

The following are shown in the drawing:

FIG. 1 A diagrammatic cross-sectional representation of an interior trim component according to an exemplary embodiment of the present invention.

### DETAILED DESCRIPTION OF AN EXEMPLARY INVENTION

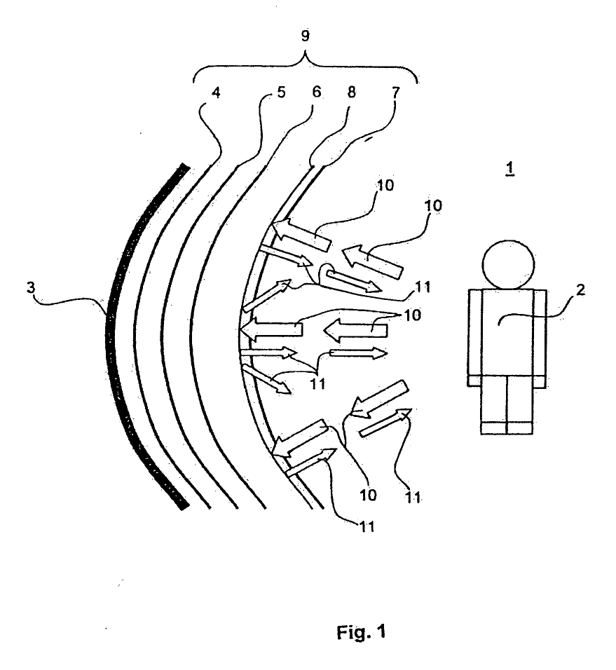

FIG. 1 shows an exemplary embodiment of the arrangement according to the invention. Within the interior compartment of a cabin 1 of a passenger aircraft there is a seated passenger 2. In the embodiment shown, the interior wall of the passenger cabin 1 comprises an interior trim component 3.

In the embodiment shown in FIG. 1, the interior trim component 3 comprises the arrangement according to the invention.

In this exemplary embodiment, the arrangement comprises an adhesive layer 4, a carrier layer 5, a colouration layer 6 as well as a transparent layer 7. For example, plastic foils made of polyvinyl fluoride (PVF), polyvinylidene fluoride (PVDF) or other plastics can be considered as materials for constituting the adhesive layer 4, the carrier layer 5, and the colouration layer 6. The adhesive layer 4 is in particular used to mechanically fix the arrangement to the interior trim component 3. The carrier layer 5 is in particular used for mechanical stabilisation of the entire foil structure of the arrangement, in particular of the colouration layer, but said carrier layer 5 can for example also comprise structures, textures, embossed patterns and the like for decorative purposes. The colouration layer 6 is predominantly for decoration in that it provides the interior trim component 3 for example with a defined colour or colour pattern as an interior design feature of the passenger aircraft. Furthermore, the colouration layer 6 can also comprise structures, textures and the like for decorative surface design. The transparent layer 7 finally enhances the aesthetic overall effect in that it additionally provides a defined gloss to the surface of the interior trim component 3.

The rear of the transparent layer 7 comprises a rear coating 8. The transparent coating 7 comprises for example a plastic foil, in particular a polyethylene foil and/or a polypropylene foil, since plastic foils made of polyolephines are permeable in particular to infrared radiation. The rear coating 8 is a metallic coating and/or a metal oxide coating, for example comprising indium-tin oxide or other metal oxides. Advantageously, silver compounds can also be used to form the coating 8.

The coating 8 may have a thermal emission coefficient E of less than 0.5. In a particularly preferred embodiment, the coating 8 has a thermal emission coefficient of between 0.1 and 0.3 so that the coating 8 reflects more than 50% of the impinging infrared radiation back to the interior 1 of the cabin. The material strength of the coating 8 may be less than 1 μm so that the coating 8 may be not perceived by the human eye, and so that there is no negative effect due to the colouration layer 6 being covered. In order to apply such thin coatings, in a particularly advantageous way, coating is applied by vacuum evaporation technique to the reverse of the foil made of polyolephines, for example a polyethylene foil or polypropylene foil, which foil constitutes the rear of the transparent layer 7. In this arrangement, the transparent layer 7 is less than 40 μm in thickness in order to meet the stringent fire protection standards prescribed in passenger aircraft engineering.

The adhesive layer 4, the carrier layer 5, the colouration layer 6 and the transparent layer 7 with the coating 8 applied to the rear, may be firmly pasted or fixed together and connected to the interior trim component 3, thus together comprising a layer arrangement 9 of the arrangement according to the invention. Of course in an alternative embodiment, not shown in FIG. 1, positioning of the arrangement, which positioning is limited to some regions only, is possible on the interior trim component 3. Furthermore, the arrangement according to the invention can also be used to coat window surfaces. In this case it may be possible that the colouration layer 6 and the carrier layer 5 within the layer arrangement are left out in places—at least in the window regions.

The heat radiation 10 emitted by a passenger 2 penetrates the transparent layer 7 almost without loss and is subsequently largely reflected back into the passenger compartment by the coating 8. The heat radiation 11 reflected by the coating 8 again impinges on the passenger 2. This reflected heat radiation 11 reduces the heat loss of the passenger 2 due to absorption, thus having an advantageous effect on the thermal perception of said passenger 2. Thus, the thermal comfort in the interior of the cabin 1, in particular in the window regions and/or near the interior trim components 3, increases. The sensation of feeling cold, which is in particular experienced on long-haul flights by passengers 2 seated near the interior trim components 3 and/or the window surfaces, may be reduced by the coating 8; in other words it is believed that a better level of comfort is attained.

At the same time, the rear coating 8 is believed to be well protected, behind the transparent layer 7—on the side of the cabin 1 which side faces away from the transparent layer 7—against external environmental influences. Consequently, for example perspiration from sweaty hands, wherein the pH value of said perspiration is below 6.5, or mechanical cleaning work, no longer have a detrimental effect on the coating 8.

Furthermore the arrangement, according to the invention, of the coating 8, may make it possible, below the transparent layer 7, to use foils made of polyolephines, for example polyethylene foils or polypropylene foils, which are clearly more economical when compared to PVF foils or PVDF foils, to form the transparent layer 7. Due to the coating 8 having been applied to the rear of the transparent layer 7, in the case of a fire the impinging infrared radiation is thrown back into the interior of the cabin 1 so that ignition of the components is retarded and the maximum permissible heat-release values of the component, which values are 65 kW min/m² according to the relevant fire protection standards, are not exceeded. Without the application of the coating 8, the maximum peak heat release value of 65 kW min/m² and the integral of the two-minute heat release rate of 65 kW min/m² would not be achievable with the known foils made from polyolephines, even with a material thickness below 40 micrometers.

In the course of specific measurements on polypropylene foils comprising indium-tin oxide on a representative interior trim component in the measuring cabin, unexpectedly low heat release values of approximately 47 kW/m² at a foil thickness of 20 and 30 μm have resulted. In this arrangement, the thermal emission coefficients ε were approximately 0.35 in each case. These measuring results were in the range that hitherto has only been achievable with correspondingly coated more expensive PVF foils or PVDF foils.

By means of the arrangement according to the invention, it is thus possible to provide a decorative design of interior trim components 3 while at the same time complying with the relevant fire protection standards, and using economical foils made of polyolephines, for example polyethylene foils or polypropylene foils, while at the same time increasing the thermal comfort in the interior of the cabin 1 of passenger aircraft.

### LIST OF REFERENCE CHARACTERS

1 Cabin
2 Passenger
3 Interior trim component
4 Adhesive layer
5 Carrier layer
6 Colouration layer
7 Transparent layer
8 Coating
9 Layer arrangement
10 Emitted heat radiation
11 Reflected heat radiation

1. An arrangement for coating interior trim components of a cabin in a passenger aircraft while complying with relevant fire protection standards, the arrangement comprising;
a layer arrangement with a first transparent layer and a plurality of second functional layers;
wherein the layer arrangement is appliable to the interior trim components;
a rear coating;
wherein the rear coating is applied to the first transparent layer in at least one region thereof at a side of the first transparent layer that faces away from an interior of the cabin of the passenger aircraft.

2. The arrangement according to claim 1,
wherein the transparent layer, at least in some regions, is permeable to infrared radiation.

3. The arrangement according to claim 1,
wherein the rear coating of the transparent layer is formed by at least one of a metal coating and a metal oxide coating; and
wherein a thickness of the rear coating is less than 2 μm.

4. The arrangement of claim 3,
wherein the rear coating is formed by an indium-tin oxide coating.

5. The arrangement according to claim 1,
wherein maximum heat-release values of the transparent layer, as a result of the rear coating, are less than 65 kW min/m² at a thickness which is comparable to that of polyvinyl fluoride foil or a polyvinylidene fluoride foil.

6. The arrangement of claim 1,
wherein a thickness of the transparent layer is less than 60 μm.

7. The arrangement of claim 1,
wherein the rear coating reflects at least half of a heat radiation back into the cabin of the passenger aircraft;
wherein the heat radiation is emitted by a passenger in a direction of the layer arrangement.

8. The arrangement of claim 1,
wherein the transparent layer is formed by a polyolephine plastic foil.

9. The arrangement of claim 8,
wherein the transparent layer is formed by at least one of a polypropylene foil and a polyethylene foil.

10. The arrangement of claim 1,
wherein the plurality of functional layers of the layer arrangement are formed by at least one carrier layer and a colouration layer.

11. The arrangement of claim 1,
wherein the layer arrangement further comprises a third adhesive layer.

12. The arrangement of claim 1, comprising an adhesive layer, a carrier layer and a colouration layer;
wherein the adhesive layer, the carrier layer and the colouration layer are made of plastic foils;
wherein the plastic foils are interconnected all over;
wherein the transparent foil is formed of a polyolephine plastic foil;
wherein the polyolephine plastic foil is interconnected, preferably all over, with the colouration layer.

13. An interior trim component for a cabin in a passenger aircraft, comprising:
a base plate;
a layer arrangement;
wherein the layer arrangement is arranged on the base plate;
wherein the layer arrangement has a first transparent layer and a second functional layer;
a rear coating;
wherein the rear coating is applied to a region at a side of the first transparent layer;
wherein the side of the transparent layer faces away from an interior of the cabin when the interior trim component is arranged in the passenger aircraft.

14. Method of manufacturing an interior trim component for a cabin in a passenger aircraft, comprising the steps of:
providing a base plate;
providing a second functional layer on the base plate;
providing a first transparent layer;
providing a rear coating in a region at a side of the transparent layer;
wherein the side faces away from an interior of the cabin when the interior trim component is arranged in the plane.
